(19) United States
(12) Patent Application Publication
(10) Pub. No.: US 2025/0323312 A1
(43) Pub. Date: Oct. 16, 2025

(54) NEW Li-CONDUCTOR PROTOTYPES IN THE Li-Sb-Cl-O CHEMICAL SPACE FOR SOLID-STATE BATTERIES

(71) Applicant: SAMSUNG ELECTRONICS CO., LTD., Suwon-si (KR)

(72) Inventors: Mahdi AMACHRAA, Cambridge, MA (US); Yan Wang, Brookline, MA (US)

(73) Assignee: SAMSUNG ELECTRONICS CO., LTD., Suwon-si (KR)

(21) Appl. No.: 18/821,169

(22) Filed: Aug. 30, 2024

Related U.S. Application Data
(60) Provisional application No. 63/634,756, filed on Apr. 16, 2024.

(51) Int. Cl. H01M 10/0562; C01B 11/06; H01M 4/13; H01M 4/62; H01M 10/052

(52) U.S. Cl. CPC H01M 10/0562; C01B 11/062; H01M 4/13; H01M 4/62; H01M 10/052; C01P 2002/50; C01P 2002/76; C01P 2006/40; H01M 2300/0071

(57) ABSTRACT

A lithium-containing oxide has one of the following parent compositions: Li2-zSbCl3O2, where z ranges from −1 to 1; Li2-zSb2Cl10O, where z ranges from −1 to 1; Li1-zSb(ClO)2, where z ranges from −0.5 to 0.5; or Li6-zSbCl3O4, where z ranges from −0.5 to 0.5. A lithium solid-state battery includes an anode, a cathode, and a solid electrolyte, wherein the solid electrolyte includes the aforementioned lithium-containing oxide. Also, a solid-state battery includes an anode, a cathode, and a solid electrolyte, wherein at least one of the anode and the cathode is coated with a coating which includes the aforementioned lithium-containing oxide.

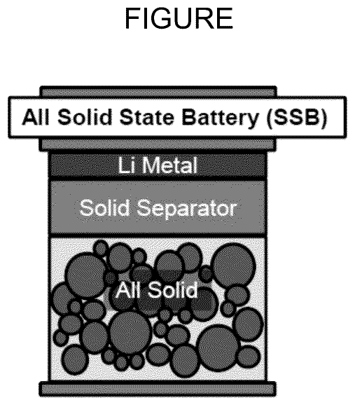

### CROSS-REFERENCE TO RELATED APPLICATION

This application is based on and claims priority from U.S. Provisional Application No. 63/634,756 filed on Apr. 16, 2024 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and/or for use as electrode coatings for solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. An all solid state battery is shown in the FIGURE. In the FIGURE, the all solid component can comprise solid cathode particles in a solid catholyte, and the solid separator can comprise a solid electrolyte.

Solid-state lithium-ion conductors with high ionic conductivities play an important role in SSBs. During the past two decades, there has been an increasing amount of work on new solid-state lithium-ion conductors (SSLICs). And most of them are focused on sulfide SSLICs with high ionic conductivities. However, very limited number of oxide materials were developed for SSBs, and so far only lithium garnet is considered to be the oxide-type electrolyte for lithium SSBs.

For solid-state electrolytes in SSBs, sulfide-based materials have high ionic conductivities (>10 mS/cm) but not really safe (H2S in air condition) and have limited electrochemical stability (for example, unstable against Li metal).

Oxide SSLICs, which own better electrochemical and chemical stability than sulfide SSLICs, have been largely limited in garnet-type materials. The ionic conductivities of reported oxide SSLICs are generally lower than those of sulfide SSLICs.

Solid state electrolyte materials with superionic conductivity and interfacial stability are desirable materials to form all-solid-state Li-metal batteries. However, several problems and challenges are currently being investigated, such as achieving high ionic conductivity at room temperature, ensuring good interfaces between solid-state electrolytes and electrode materials, developing cost-effective solid-state-electrolytes that can compete with currently established liquid electrolyte technologies is also a hurdle for widespread adoption. Currently, very few Li-oxide conductors have been uncovered. Consequently, discovering new compositions within the Li-Sb-Cl-O chemical space is a promising venture to uncover simple, cost-effective, high stability Li-conductors.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—Sb—Cl—O chemical space by applying a machine learning-based crystal structure prediction algorithm.

In this disclosure, novel lithium-containing oxides include the following parent compositions: Li2-zSbCl3O2 (z ranges from −1 to 1), Li2-zSb2Cl10O (z ranges from −1 to 1), Li1-zSb(ClO)2 (z ranges from −0.5 to 0.5), Li6-zSbCl3O4 where z ranges from −0.5 to 0.5.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

A first embodiment of the present disclosure provides a lithium-containing oxide of one of the following parent compositions: Li2-zSbCl3O2, where z ranges from −1 to 1; Li2-zSb2Cl10O, where z ranges from −1 to 1; Li1-zSb(ClO)2, where z ranges from −0.5 to 0.5; or Li6-zSbCl3O4, where z ranges from −0.5 to 0.5.

A second embodiment of the present disclosure provides a lithium-containing oxide of the first embodiment, wherein the lithium-containing oxide is a lithium-containing oxide of the parent composition Li2-zSbCl3O2, where z ranges from −1 to 1.

A third embodiment of the present disclosure provides a lithium-containing oxide of the first embodiment, wherein the lithium-containing oxide is a lithium-containing oxide of the parent composition Li2-zSb2Cl10O, where z ranges from −1 to 1.

A fourth embodiment of the present disclosure provides a lithium-containing oxide of the first embodiment, wherein the lithium-containing oxide is a lithium-containing oxide of the parent composition Li1-zSb(ClO)2, where z ranges from −0.5 to 0.5.

A fifth embodiment of the present disclosure provides a lithium-containing oxide of the first embodiment, wherein the lithium-containing oxide is a lithium-containing oxide of the parent composition Li6-zSbCl3O4, where z ranges from −0.5 to 0.5.

A sixth embodiment of the present disclosure provides a lithium-containing oxide of the first embodiment, wherein the lithium-containing oxide is Li2Sb2Cl10O.

A seventh embodiment of the present disclosure provides a lithium-containing oxide of the first embodiment, wherein the lithium-containing oxide is Li2SbCl3O2.

An eighth embodiment of the present disclosure provides a lithium-containing oxide of the first embodiment, wherein the lithium-containing oxide is Li6SbCl3O4.

A ninth embodiment of the present disclosure provides a lithium-containing oxide of the first embodiment, wherein the lithium-containing oxide is LiSb(ClO)2.

A tenth embodiment of the present disclosure provides a lithium-containing oxide of the seventh embodiment, wherein the Li2SbCl3O2 is crystallized in space group C2/c.

An eleventh embodiment of the present disclosure provides a lithium-containing oxide of the seventh embodiment, wherein the Li2SbCl3O2 is crystallized in space group P2₁/c.

A twelfth embodiment of the present disclosure provides a lithium-containing oxide of the ninth embodiment, wherein the LiSb(ClO)2 is crystallized in space group C2/c.

A thirteenth embodiment of the present disclosure provides a lithium-containing oxide of the ninth embodiment, wherein the LiSb(ClO)2 is crystallized in space group P2₁/c.

A fourteenth embodiment of the present disclosure provides a lithium solid-state battery comprising an anode, a cathode, and a solid electrolyte, wherein the solid electrolyte comprises a lithium-containing oxide of the first embodiment.

A fifteenth embodiment of the present disclosure provides a lithium solid-state battery of the fourteenth embodiment, wherein the solid electrolyte comprises Li2SbCl3O2.

A sixteenth embodiment of the present disclosure provides a lithium solid-state battery of the fourteenth embodiment, wherein the solid electrolyte comprises Li2Sb2Cl10O.

A seventeenth embodiment of the present disclosure provides a lithium solid-state battery of the fourteenth embodiment, wherein the solid electrolyte comprises LiSb(ClO)2.

An eighteenth embodiment of the present disclosure provides a lithium solid-state battery of the fourteenth embodiment, wherein the solid electrolyte comprises an anolyte which comprises Li6SbCl3O4.

A nineteenth embodiment of the present disclosure provides a solid-state battery comprising an anode, a cathode, and a solid electrolyte, wherein at least one of the anode and the cathode is coated with a coating which comprises a lithium-containing oxide of the first embodiment.

A twentieth embodiment of the present disclosure provides a lithium solid-state battery of the nineteenth embodiment, wherein the coating comprises Li2SbCl3O2, Li2Sb2Cl10O, LiSb(ClO)2, or Li6SbCl3O4.

### BRIEF DESCRIPTION OF DRAWINGS

Example embodiments of the present disclosure will be more clearly understood from the following detailed description taken in conjunction with the accompanying drawing in which:

The FIGURE shows an all solid-state battery.

### DETAILED DESCRIPTION OF EXAMPLE EMBODIMENTS

The present disclosure demonstrates several novel compositions within the Li—Sb—Cl—O chemical space with Li-ion conductivity.

In this disclosure, novel lithium-containing oxides include the following parent compositions: Li2-zSbCl3O2 (z ranges from −1 to 1), Li2-zSb2Cl10O (z ranges from −1 to 1), Li1-zSb(ClO)2 (z ranges from −0.5 to 0.5), Li6-zSbCl3O4 (z ranges from −0.5 to 0.5). In this regard, it is noted that there can be lithium deficiency associated with oxygen loss in lithium oxide compounds. A general formula for this disclosure can be, e.g., Li2-zSbCl3O2-w (z ranges from −1 to 1and w ranges from −0.5 to 0.5), Li2-zSb2Cl10O1-w (z ranges from −1 to 1and w ranges from −0.5 to 0.5), Li1-zSbCl2O2-w (z ranges from −0.5 to 0.5and w ranges from −0.25 to 0.25), Li6-zSbCl3O4-w (z ranges from −0.5 to 0.5and w ranges from −0.25 to 0.25). This disclosure also includes the general formula Li2-zSbCl3O2-w (z ranges from −1 to 1and w ranges from 0 to 0.5), Li2-zSb2Cl10O1-w (z ranges from −1 to 1and w ranges from 0 to 0.5), Li1-zSbCl2O2-w (z ranges from −0.5 to 0.5and w ranges from 0 to 0.25), Li6-zSbCl3O4-w (z ranges from −0.5 to 0.5and w ranges from 0 to 0.25).

In this disclosure, novel Li-ion prototypes within the Li—Sb—Cl—O chemical space include the following formulas: Li2SbCl3O2, Li2Sb2Cl10O, LiSb(ClO)2, Li6SbCl3O4.

The Li2SbCl3O2 composition may crystallize in 2 distinct space groups: C2/c and P2₁/c, with energies above hull of 35 meV/atom and 42 me V/atom, respectively. The Li activation energies are 0.20 eV (1-dimensional), 0.21 eV (2-dimensional), 0.24 eV (3-dimensional) for the C2/c phase. The Li activation energies are 0.26 eV (1-dimensional), 0.64 eV (2-dimensional), 0.73 eV (3-dimensional) for the P2₁/c phase. For both phases, the reduction potential against Li is 3.46 V, and the oxidation potential is 3.86 V, suggesting that these phases can be used as an electrolyte (in batteries, these materials as solid-state electrolyte can form solid-electrolyte interphases by chemical-reaction with electrodes and widen the redox potential window of the electrolytes). The reaction energy between these phases and H2O is higher than −0.20 eV/atom, suggesting a relatively high aqueous stability.

The Li2Sb2Cl10O composition crystallizes in the P2₁/m phase and has an energy above hull of 45 meV/atom. The Li activation energy is 0.23 eV (1-dimensional), 0.29 eV (2-dimensional) and 0.3 eV (3-dimensional). The reduction potential against Li is 3.46 V and the oxidation potential is 3.86 V, suggesting that this material can be used as an electrolyte. The reaction energy between this phase and H2O is −0.11 eV/atom, suggesting a relatively stable aqueous stability.

The LiSb(ClO)2 composition crystallizes in two space groups, namely, C2/c and P2₁/c, with energies above hull of 5.5 meV/atom, and 57 me V/atom, respectively. The Li activation energy for the C2/c phase is 0.53 eV (1-dimensional), 0.66 eV (2-dimensional), 0.67 eV (3-dimensional). The Li activation energy for the P2₁/c phase is 0.49 eV (1-dimensional), 0.51 eV (2-dimensional), 1.86 eV (3-dimensional). The reduction potential against Li for both phases is 3.46 V and the oxidation potential is 3.86 V, suggesting that these phases can be used as electrolyte. The reaction energy between the two phases and H2O is higher than −0.20 eV/atom, suggesting a relatively good water stability.

The Li6SbCl3O4 composition crystallizes in the P6₃ space group and has an energy above hull of 57 meV/atom. The Li activation energies are 0.56 eV (1-dimensional), 0.75 eV (2-dimensional), 0.76 eV (3-dimensional). The reduction potential against Li for this phase is 1.63 V and the oxidation potential is 3.26 V, suggesting that this phase can be used as an anolyte against Li-alloy anode. The reaction energy between this phase and H2O is 0 meV/atom suggesting a high aqueous stability.

High-throughput data-mining was conducted to derive novel prototype Li-containing structures, and advanced data analytics was performed to extract novel Li-ion conductors that are stable against Li metal, stable anolyte against various types of anodes such as alloy anode or graphite anode, stable catholytes and stable coating materials in all-solid state batteries.

The lithium-containing oxides in this disclosure can be made by a standard solid-state method. In this method, precursor powders are combined in a certain ratio depending on the composition of the target material. As one example, precursors may consist of lithium carbonate (Li₂CO₃), antimony oxide (Sb₂O₃), and lithium chloride (LiCl), and as another example, precursors may consist of lithium oxide (Li₂O), antimony oxide, and lithium chloride.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature (e.g., 500-1000° C.) for an appropriate period of time (e.g., 6-12 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., 6-12 hours) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

### EXAMPLES

Embodiments will now be illustrated by way of the following examples, which do not limit the embodiments in any way.

A machine learning-based crystal structure prediction algorithm was applied to obtain the following compositions as set forth in Table 1.

TABLE 1

| | | | | | | | | | H2O | | | |
|---|---|---|---|---|---|---|---|---|---|---|---|---|
| Host | | Chemical | Mobile | | | | | | RxN | H2O | | |
| ID | Formula | Space | Ion | E_1D | E_2D | E_3D | Vred | Vox | Energy | Content | Ehull | SPG |
| 6358 | Li2Sb2Cl10O | Cl—Li—O—Sb | Li1+ | 0.23 | 0.29 | 0.3 | 3.46 | 3.86 | −0.11 | 0.87 | 45.29 | P2₁/m |
| 5965 | Li2SbCl3O2 | Cl—Li—O—Sb | Li1+ | 0.26 | 0.64 | 0.73 | 3.46 | 3.86 | −0.18 | 0.51 | 42.78 | P2₁/c |
| 6446 | Li2SbCl3O2 | Cl—Li—O—Sb | Li1+ | 0.2 | 0.21 | 0.24 | 3.46 | 3.86 | −0.15 | 0.51 | 35.23 | C2/c |
| 6019 | Li6SbCl3O4 | Cl—Li—O—Sb | Li1+ | 0.56 | 0.75 | 0.76 | 1.63 | 3.26 | 0.0 | −0.0 | 57.04 | P6₃ |
| 5613 | LiSb(ClO)2 | Cl—Li—O—Sb | Li1+ | 0.53 | 0.66 | 0.67 | 3.46 | 3.86 | −0.03 | 0.51 | 5.51 | C2/c |
| 5980 | LiSb(ClO)2 | Cl—Li—O—Sb | Li1+ | 0.49 | 0.51 | 1.86 | 3.46 | 3.86 | −0.18 | 0.51 | 56.77 | P2₁/c |

As can be seen from the results presented in Table 1, the 3.46 V reduction potential against Li and the 3.86 V oxidation potential for both space groups for the Li2SbCl3O2 composition suggest that the composition can be used as an electrolyte in both cases (again, in batteries, these materials as solid-state electrolyte can form solid-electrolyte interphases by chemical reaction with electrodes and widen the redox potential window of the electrolytes; this applies to the materials below as well), and the reaction energy between these phases and H2O is higher than −0.20 eV/atom, suggesting a relatively high aqueous stability. Also, the 3.46 V reduction potential against Li and the 3.86 V oxidation potential for the P2₁/m phase of the Li2Sb2Cl10O composition suggest that the composition can be used as an electrolyte, and the reaction energy between this phase and H2O is −0.11 eV/atom, suggesting a relatively high aqueous stability. In addition, the 3.46 V reduction potential against Li and the 3.86 V oxidation potential for both space groups for the LiSb(ClO)2 composition suggest that the composition can be used as an electrolyte in both cases, and the reaction energy between these phases and H2O is higher than −0.20 eV/atom, suggesting a relatively good water stability. Further, the 1.63 V reduction potential against Li and the 3.26 V oxidation potential for the P63 phase of the Li6SbC1304 composition suggest that the composition can be used as an electrolyte, and the reaction energy between this phase and H2O is 0 eV/atom, suggesting a high aqueous stability.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium-containing oxide of one of the following parent compositions:
Li2-zSbCl3O2, where z ranges from −1 to 1;
Li2-zSb2Cl10O, where z ranges from −1 to 1;
Li1-zSb(ClO)2, where z ranges from −0.5 to 0.5; or Li6-zSbCl3O4, where z ranges from −0.5 to 0.5.

2. The lithium-containing oxide of claim 1, wherein the lithium-containing oxide is a lithium-containing oxide of the parent composition Li2-zSbCl3O2, where z ranges from −1 to 1.

3. The lithium-containing oxide of claim 1, wherein the lithium-containing oxide is a lithium-containing oxide of the parent composition Li2-zSb2Cl10O, where z ranges from −1 to 1.

4. The lithium-containing oxide of claim 1, wherein the lithium-containing oxide is a lithium-containing oxide of the parent composition Li1-zSb(ClO)2, where z ranges from −0.5 to 0.5.

5. The lithium-containing oxide of claim 1, wherein the lithium-containing oxide is a lithium-containing oxide of the parent composition Li6-zSbCl3O4, where z ranges from −0.5 to 0.5.

6. The lithium-containing oxide of claim 1, wherein the lithium-containing oxide is Li2Sb2Cl10O.

7. The lithium-containing oxide of claim 1, wherein the lithium-containing oxide is Li2SbCl3O2.

8. The lithium-containing oxide of claim 1, wherein the lithium-containing oxide is Li6SbCl3O4.

9. The lithium-containing oxide of claim 1, wherein the lithium-containing oxide is LiSb(ClO)2.

10. The lithium-containing oxide of claim 7, wherein the Li2SbCl3O2 is crystallized in space group C2/c.

11. The lithium-containing oxide of claim 7, wherein the Li2SbCl3O2 is crystallized in space group P2₁/c.

12. The lithium-containing oxide of claim 9, wherein the LiSb(ClO)2 is crystallized in space group C2/c.

13. The lithium-containing oxide of claim 9, wherein the LiSb(ClO)2 is crystallized in space group P2₁/c.

14. A lithium solid-state battery comprising an anode, a cathode, and a solid electrolyte, wherein the solid electrolyte comprises a lithium-containing oxide of claim 1.

15. The lithium solid-state battery of claim 14, wherein the solid electrolyte comprises Li2SbCl3O2.

16. The lithium solid-state battery of claim 14, wherein the solid electrolyte comprises Li2Sb2Cl10O.

17. The lithium solid-state battery of claim 14, wherein the solid electrolyte comprises LiSb(ClO)2.

18. The lithium solid-state battery of claim 14, wherein the solid electrolyte comprises an anolyte which comprises Li6SbCl3O4.

19. A solid-state battery comprising an anode, a cathode, and a solid electrolyte, wherein at least one of the anode and the cathode is coated with a coating which comprises a lithium-containing oxide of claim 1.

20. The lithium solid-state battery of claim 19, wherein the coating comprises Li2SbCl3O2, Li2Sb2Cl10O, LiSb(ClO)2, or Li6SbCl3O4.
